(19) United States
(12) Patent Application Publication
(10) Pub. No.: US 2025/0037207 A1
(43) Pub. Date: Jan. 30, 2025

(54) REAL-TIME DIGITAL SIMULATION AND DAMAGE ASSESSMENT FOR A DETECTED EVENT

(71) Applicant: International Business Machines Corporation, Armonk, NY (US)

(72) Inventors: Sarbajit K. Rakshit, Kolkata (IN); Aaron K. Baughman, Cary, NC (US); Tushar Agrawal, West Fargo, ND (US); Jennifer M. Hatfield, Portland, OR (US); Vinod A. Valecha, Pune (IN)

(21) Appl. No.: 18/360,424

(22) Filed: Jul. 27, 2023

(51) Int. Cl. G06Q 40/08

(52) U.S. Cl. CPC G06Q 40/08

(57) ABSTRACT

Embodiments of the present invention provide an approach for event damage assessment. Specifically, the approach provides for obtaining sensor data from objects with sensors in an activity area and detecting events based on this data. A real-time digital simulation is generated to estimate the damages caused by the detected event. A directed acyclic graph is created to model similar scenario causation factors, which is then refined using data analysis and simulations to create an augmented directed acyclic graph. A neural network architecture is applied to the augmented directed acyclic graph to classify faults. An insurance claim amount is calculated based on the estimated damages amount and the classified fault.

### TECHNICAL FIELD

The present invention relates to event damage assessment, and more specifically to embodiments for providing a real-time digital simulation and damage assessment in response to a detected event.

### BACKGROUND

On an industrial floor, various activities can be carried out in a specific sequence known as a workflow. During the execution of these workflows, different contextual scenarios can arise, such as accidents, issues with machines or devices, and mishandling of materials. These scenarios can have an impact on the health and performance of machines, devices, and structures.

To address these challenges, digital simulation can be employed to assess the condition of machines, devices, and structures. Through predictive and situational analysis, it can become possible to identify areas that are more prone to issues compared to others. Additionally, this analysis can enable the identification of trends across multiple workflows, enterprises, and user groups.

### SUMMARY

Embodiments of the present invention provide an approach for real-time digital simulation and damage assessment in response to a detected event. Specifically, the approach provides for obtaining sensor data from objects with sensors in an activity area and detecting events based on this data. A real-time digital simulation is generated to estimate the damages caused by the detected event. A directed acyclic graph is created to model similar scenario causation factors, which is then refined using data analysis and simulations to create an augmented directed acyclic graph. A neural network architecture is applied to the augmented directed acyclic graph to classify faults. An insurance claim amount is calculated based on the estimated damages amount and the classified fault.

A first aspect of the present invention provides a method for assessing event damage, comprising: obtaining, by an assessment engine, sensor data from objects having sensors within an activity area; detecting, by the assessment engine, an event based on the sensor data; generating, by the assessment engine, a real-time digital simulation to estimate a damages amount caused by the detected event; generating, by the assessment engine, a directed acyclic graph to model similar scenario causation factors; refining, by the assessment engine, the directed acyclic graph using data analysis and simulations to create an augment directed acyclic graph; applying, by the assessment engine, a neural network architecture to the augmented directed acyclic graph to classify a fault; and calculating, by the assessment engine, an insurance claim amount based on the estimated damages amount and the classified fault.

A second aspect of the present invention provides a computing system for assessing event damage, comprising: a processor; a memory device coupled to the processor; and a computer readable storage device coupled to the processor, wherein the storage device contains program code executable by the processor via the memory device to implement a method, the method comprising: obtaining, by an assessment engine, sensor data from objects having sensors within an activity area; detecting, by the assessment engine, an event based on the sensor data; generating, by the assessment engine, a real-time digital simulation to estimate a damages amount caused by the detected event; generating, by the assessment engine, a directed acyclic graph to model similar scenario causation factors; refining, by the assessment engine, the directed acyclic graph using data analysis and simulations to create an augment directed acyclic graph; applying, by the assessment engine, a neural network architecture to the augmented directed acyclic graph to classify a fault; and calculating, by the assessment engine, an insurance claim amount based on the estimated damages amount and the classified fault.

A third aspect of the present invention provides a computer program product for assessing event damage, the computer program product comprising a computer readable storage device, and program instructions stored on the computer readable storage device, to: obtain, by an assessment engine, sensor data from objects having sensors within an activity area; detect, by the assessment engine, an event based on the sensor data; generate, by the assessment engine, a real-time digital simulation to estimate a damages amount caused by the detected event; generate, by the assessment engine, a directed acyclic graph to model similar scenario causation factors; refine, by the assessment engine, the directed acyclic graph using data analysis and simulations to create an augment directed acyclic graph; apply, by the assessment engine, a neural network architecture to the augmented directed acyclic graph to classify a fault; and calculate, by the assessment engine, an insurance claim amount based on the estimated damages amount and the classified fault.

### BRIEF DESCRIPTION OF THE DRAWINGS

FIG. 1 depicts a block diagram illustrating an example of an environment for the execution of at least some of the computer code involved in performing the inventive methods, in accordance with embodiments of the present invention.

FIG. 2 depicts a block diagram of a system architecture involved in performing the inventive methods, in accordance with embodiments of the present invention.

FIG. 3 depicts a flow diagram related to providing a real-time digital simulation and insurance claim submission in response to a detected event, in accordance with an embodiment of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

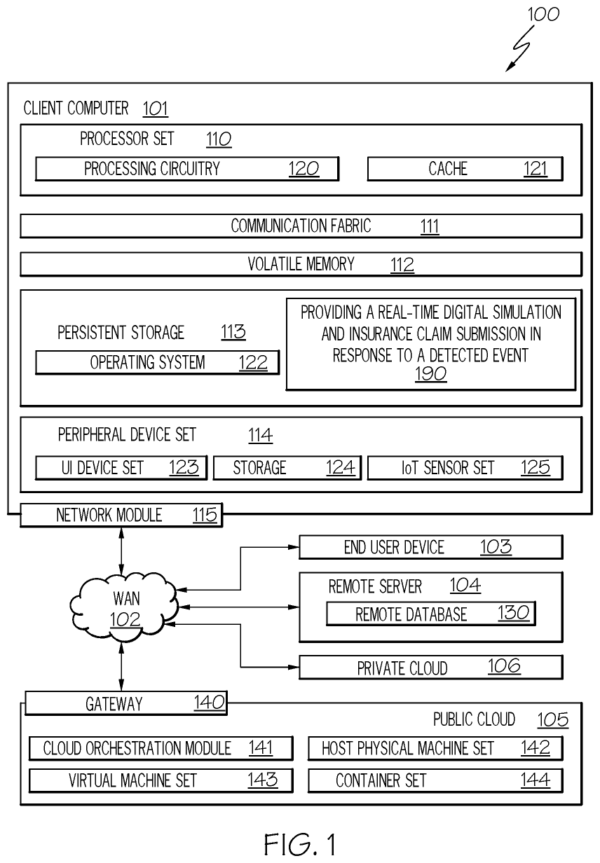

Computing environment 100 of FIG. 1 contains an example of an environment for the execution of at least some of the computer code involved in performing the inventive methods, such as providing a real-time digital simulation and insurance claim submission in response to a detected event technique 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

As used herein, “digital simulation” refers to the use of computer-based models and algorithms to replicate and analyze real-world scenarios or systems. It involves creating a digital representation of a physical object, process, or environment and simulating its behavior, performance, or interactions under various conditions. In digital simulation, mathematical equations and algorithms are utilized to mimic the behavior and dynamics of the real-world system. These simulations can range from simple models that represent basic interactions to complex, highly detailed simulations that replicate intricate systems with multiple variables and parameters. By running simulations, users can observe and analyze how a system or process behaves in different situations, identify potential issues or inefficiencies, and make improvements or adjustments accordingly. It provides a virtual environment where the performance, reliability, safety, and efficiency of a system can be evaluated and optimized.

Also, the terms “IoT” and the “Internet of Things” refer to a network of interconnected physical devices, vehicles, appliances, and other objects embedded with sensors, software, and connectivity capabilities. These devices can collect and exchange data, allowing them to interact and communicate with each other, as well as with humans, over the internet. The primary objective of IoT is to enable the seamless integration of the physical and digital worlds, creating a network of smart devices that can improve efficiency, convenience, and productivity. IoT devices can gather and transmit data in real-time, providing valuable insights and enabling intelligent decision-making.

In any activity area, whether it be an industrial floor, construction site, or rescue operation, the execution of workflows is an integral part of the daily operations. However, during the course of these workflows, unexpected events can occur, such as accidents or faulty steps, which can lead to damage or disruption in machines, structures, or work products. To effectively address these potential issues, it is crucial to determine the optimal timing for conducting digital simulations on the affected machines, structures, or work products. By leveraging digital simulation techniques, the health and condition of these elements can be assessed accurately, providing valuable insights into the impact of the events that have occurred.

Digital simulation, when combined with real-time data from Internet of Things (IoT) devices, allows for the prompt detection and analysis of these events. By capturing and analyzing data from sensors, cameras, or other IoT devices, it becomes possible to reconstruct and understand what happened during the event. This comprehensive understanding enables organizations to determine the extent of the damage, identify the root causes, and take appropriate measures to mitigate future risks. In an embodiment, the disclosed approach facilitates the insurance claiming process. By providing detailed information about the event and its impact, organizations can ensure that insurance claims are accurately filed to cover the damages resulting from these events. In any case, the disclosed approach not only helps in the timely recovery of losses but also promotes a proactive approach towards risk management and prevention.

The disclosed approach provides an Artificial Intelligence (AI)-enabled system to predict and assess the potential damage or impact on machines, structures, and/or other objects in an activity area based on identified events, such as accidents or improper execution of steps. By analyzing IoT feeds, the system can quickly determine if the detected event may result in damage. The system provides the ability to analyze historical data from IoT feeds to distinguish changes in machines and structures due to normal wear and tear from changes caused by the detected event. This analysis allows for accurate assessments to be made specifically for the damages resulting from the event, ensuring that only relevant and valid claims are made.

The system also uses digital twin simulations to estimate the required changes to bring the affected machines or structures back to their original state. By simulating the effects of the event, the system can calculate the appropriate insurance claim amount based on the necessary repairs or adjustments needed to restore the damaged objects. Also, the proposed system incorporates image analysis from the activity area to identify the underlying reasons for the event, such as insufficient preventive maintenance. By utilizing smart contract rules, the system can validate the level of compliance with maintenance protocols and calculate the insurance claim amount accordingly.

The invention further involves the augmentation of causal graphs from digital simulations. By identifying invariance of parameters between simulations, the system can create augmented causal graphs that represent the most likely reasons for the damage, providing valuable insights for further analysis and prevention. Overall, the disclosed approach enhances the accuracy and efficiency of assessing damages, filing insurance claims, and identifying the root causes of events in activity areas, leading to improved risk management and prevention strategies.

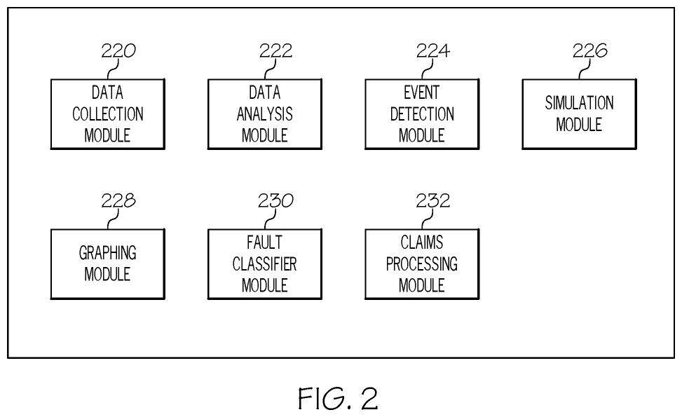

FIG. 2 depicts a block diagram of one or more components of a system environment 200 by which services provided by an assessment engine 250 may be offered as cloud services, in accordance with an embodiment of the present disclosure. In accordance with some embodiments, the assessment engine 250 is configured to predict and assess potential damage to machines and structures based on identified events, ensuring accurate insurance claims are made. As used herein, an “engine” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, an “engine” can refer to a combination of a hardware processing circuit and machine-readable instructions (software and/or firmware) executable on the hardware processing circuit.

As shown in FIG. 2, assessment engine 250 may include one or more modules, such as data collection module 220, data analysis module 222, event detection module 224, simulation module 226, graphing module 228, fault classifier module 230, and claims processing module 232. As described in detail below, assessment engine 250 can utilize data collection module 220 to gather data from sensors, which can be then analyzed by data analysis module 222 to identify patterns or anomalies within the data. Event detection module 224 can detect an event from the collected data. Once an event is detected, simulation module 226 can provide a real-time digital simulation to assess the damages caused by the event. A directed acyclic graph (DAG) can be generated by graphing module 228 to capture relationships between different events. The generated DAG can be refined to incorporate additional information and insights. Fault classifier module 230 can apply a graph-based neural network to categorize different types of faults. Claims processing module 232 can calculate the insurance claim amount based on the damages estimated through the digital twin simulation and submit the insurance claim.

Data collection module 220 is configured to capture and collect Internet of Things (IoT) sensor data from machines, structures, and/or other objects in an activity area. In various activities or industries, IoT sensors can be utilized to continuously capture data that helps identify the health and performance of machines, structures, and processes. These sensors are designed to monitor specific parameters and provide real-time information about the conditions and activities taking place.

IoT sensors, also known as Internet of Things sensors, are electronic devices that are embedded in physical objects or environments to collect data about various parameters. These sensors are a fundamental component of IoT systems as they enable the monitoring and measurement of different variables. IT sensors can be designed to measure a wide range of parameters, including temperature, humidity, pressure, light intensity, motion, proximity, sound, gas levels, and more. They can be categorized into different types based on their functionality, such as environmental sensors, motion sensors, proximity sensors, and biomedical sensors. Once the sensor data is transmitted, it can be further processed, analyzed, and visualized to derive meaningful insights. This can involve techniques such as data aggregation, filtering, and analytics to extract valuable information from the collected data.

Data analysis module 222 is configured to analyze the IoT feeds from the activity area to identify a sensor feed that is related to a problem with a machine that requires regular maintenance. To that end, data analysis module 222 can utilize a deep reinforcement learning algorithm, which involves training an artificial agent to make optimal decisions in an environment to maximize a reward signal. For example, data analysis module 222 can train a deep reinforcement learning model specifically designed to analyze sensor data from a fleet of trucks and predict when maintenance is needed. Data analysis module 222 can receive inputs from various truck sensors, such as tire pressure, oil temperature, and engine RPM. Using this data, data analysis model 222 can take actions to predict maintenance requirements, such as scheduling a tune-up or replacement of a specific part.

During the training process, data analysis module 222 can be provided with a reward signal based on the accuracy of its predictions. This reward signal is determined by a human operator based on the actual needs of the system being analyzed. As a result, the model adjusts its actions to enhance the accuracy of its predictions. Once the model is trained, it can be deployed to analyze real-time data from a variety of sources. For example, in the case of a fleet of trucks, data analysis module 222 can leverage sensor data to predict when maintenance is required and promptly notify the human operator to schedule the necessary tasks. By utilizing deep reinforcement learning, data analysis module 222 effectively identifies patterns in the data and predicts maintenance requirements. This capability significantly reduces downtime and extends the lifespan of equipment, contributing to improved operational efficiency and cost savings.

Event detection module 224 is configured to continuously receive IoT feeds and identify if any sensor feed is related to an event such as an accident or improper execution. The event detection module 224 is designed to constantly receive IoT feeds, which are data streams from various sensors deployed in the activity area. These sensors capture information about the machines, structures, or work products involved in the workflow. To identify if any sensor feed is related to an event, event detection module 224 can utilize advanced algorithms and machine learning techniques. The continuous monitoring and analysis of IoT feeds by event detection module 224 can ensure that events are promptly detected, allowing for immediate response and accurate damage assessment. This proactive approach can aid in minimizing losses, enhancing safety measures, and/or improving the overall efficiency of the workflow in various activity areas.

These algorithms analyze the incoming IoT feeds in real-time, looking for patterns or anomalies that indicate the occurrence of an event. For example, sudden changes in sensor readings or unusual sensor data patterns can be indicative of accidents, faults, or improper execution. Alternatively or in addition, event detection module 224 can compare the incoming sensor feeds against predefined criteria or thresholds to determine if they meet the criteria for an event. These criteria may be based on historical data, industry standards, or specific parameters set by a user.

In an embodiment, event detection module 224 is further configured to validate whether the detected event is covered by insurance. When an event is detected, such as an accident or a damage, event detection module 224 can analyze the details and characteristics of the event to determine if it falls within the scope of coverage provided by an insurance policy. This analysis involves comparing the detected event with the predefined rules and criteria that specify the types of events covered by the insurance policy. If the detected event satisfies the predefined rules and criteria, event detection module 224 confirms that the event is covered by insurance. On the other hand, if the detected event does not meet the requirements for insurance coverage, event detection module 224 can indicate that the event is not covered. This information can be used to inform the policyholder, or any relevant parties involved in the event, allowing them to take appropriate actions accordingly.

Upon identifying a relevant event, simulation module 226 is configured to initiate digital simulations to recreate the sequence of events leading up to the incident. By combining the IoT feeds with the digital simulation, a more comprehensive understanding of the event and its surrounding circumstances can be achieved. This integration allows for a detailed analysis of the impact, damage, or fault that occurred during the workflow.

In this context, “digital twin simulation” refers to a virtual replica or model of the physical machine or structure that is being monitored. The digital twin simulation is created by collecting and integrating real-time data from IoT feeds and other sources related to the activity area. The digital twin simulation allows for the prediction and assessment of potential damages or impacts on the machine or structure based on identified events.

To perform the digital twin simulation, simulation module 226 can consider various factors such as the current state of the machine or structure, environmental conditions, and the specific event that has been detected. Simulation module 226 can use algorithms and models to analyze the data and simulate the potential effects of the event on the machine or structure. For example, if the event is a sudden increase in vibrations in an industrial floor, simulation module 226 can use the digital twin simulation to predict the potential damages that could occur, such as cracks or structural instability. By comparing the current state of the machine or structure with the simulated state after the event, simulation module 226 can determine the magnitude and types of damages that may have occurred.

In an embodiment, graphing module 228 is configured to generate a directed acyclic graph (DAG) from similar situations. This DAG will be very broad, allowing it to model similar scenario causation factors. To that end, the DAG identifies similar events or situations that have occurred in the past and constructs a broad graph that represents the causal relationships between these events. The process of identifying similar events typically involves comparing various attributes or characteristics of events to find patterns or similarities. This can be achieved through different methods, including statistical analysis, machine learning algorithms, expert knowledge, and/or the like. By analyzing this graph, graphing module 228 can gain insights into the causation factors that contribute to certain scenarios. This information can then be used for predicting and assessing potential damages or impacts on machines and structures in the activity area.

Through the digital simulation, graphing module 228 is further configured to identify the specific types of damage that occur in the activity area. By analyzing the data collected during the simulation, which includes various parameters and measurements related to the activity and its impact, graphing module 228 can determine the observed or predicted damages. To enhance the understanding of the causal factors underlying these damages, graphing module 228 again can apply methods such as statistical analysis, machine learning algorithms, or expert knowledge. This analysis is used to create an augmented directed acyclic graph (DAG) that refines the initial broad DAG.

The augmented DAG can incorporate specific insights and knowledge related to the observed damages, capturing the causal relationships and factors contributing to each type of damage. This refined DAG can provide a more precise and detailed representation of the scenario's causation factors. The refined DAG can serve various purposes, including predicting the likelihood of specific damages, assessing risks, and suggesting preventive measures. The refined DAG can become a valuable tool for decision-making and planning, enabling the mitigation of damages and ensuring the safety and efficiency of the activity in the area.

In an embodiment, a causal graph is created from graph constructs based on variable invariance between similar damage claims. This broad-based causal graph serves as a powerful tool for understanding the relationships and dependencies between different variables in the insurance claim process. Graphing module 228 can utilize the causal graph to create augmented DAGs that can capture the evolving states and relationships between events and variables. The augmented DAGs can provide a more comprehensive and detailed representation of the system dynamics.

Through simulation, data can be generated that creates similar or dissimilar states, allowing for the exploration of various scenarios. These simulated states are then be used to update and expand the augmented DAGs, incorporating new insights and patterns. The augmented DAGs can be utilized for insurance claim question and answering, enabling more accurate and efficient responses to inquiries related to claims. Also, the growing DAGs can also be leveraged for fault classification, as discussed below.

Fault classifier module 230 is configured to classify faults by leveraging a graph-based neural network that operates on top of an augmented directed acyclic graph (DAG). The DAG is constructed to represent the system or process being analyzed, where nodes depict different components or entities, and edges represent the relationships between them. The DAG can further include additional information like sensor data, system states, or other relevant features to enhance its representation.

The augmented DAG can be inputted into the graph-based neural network. This type of neural network architecture is specifically designed to process and analyze graph-structured data, allowing it to effectively capture the relationships and dependencies between the nodes in the DAG. The graph-based neural network can perform feature extraction on the augmented DAG, aiming to extract meaningful patterns and representations from the graph structure and the associated features.

During the feature extraction process, the neural network can perform computations on the nodes and edges of the graph, considering both the local information of each node and the global information of the entire graph. This allows the neural network to learn and capture intricate relationships and dependencies between the components in the system, which are crucial for fault classification. Once the feature extraction is completed, the graph-based neural network can employ these learned features to classify faults. The neural network is trained on a labeled dataset, where faults are associated with specific patterns or characteristics within the augmented DAG. Through an optimization process, the neural network can learn to identify and differentiate between different fault types based on the extracted features.

Claims processing module 232 is configured to utilize smart contract rules for calculating an insurance claim and subsequently submitting it. Based on an identified fault, claims processing module 232 can determine the appropriate rules and calculations to be applied to the insurance claim. These rules are predefined within the smart contract, ensuring transparency, accuracy, and consistency in the claims calculation process. The smart contract rule can consider various factors such as the fault severity, policy terms and conditions, coverage limits, and any other relevant information. By incorporating these parameters, claims processing module 232 can accurately calculate an insurance claim amount.

Once the claim calculation is complete, claims processing module 232 can proceed to submit an insurance claim. This may involve generating the necessary documentation, such as claim forms and supporting evidence, and initiating the claim submission process with the relevant parties, such as insurance providers or claims adjusters. By leveraging the smart contract rule and automation within claims processing module 232, the insurance claim calculation and submission process becomes streamlined and efficient. It can eliminate the potential for human error, reduce processing time, and ensure compliance with the predefined rules and policies. This can lead to a more seamless and reliable insurance claims experience for both the policyholders and the insurance providers.

The disclosed AI-enabled system offers multiple advantages to the insurance claim process, particularly with damage assessment and validation. Through the analysis of IoT feeds and the utilization of digital twin simulations, the system can accurately predict and identify potential damages caused by detected events in an activity area. This facilitates the immediate execution of simulations to determine the magnitude and types of damages, ensuring precise insurance claim submissions. Leveraging historical learning enables the system to differentiate between damages resulting from normal wear and tear versus those caused by detected events, guaranteeing that claims are only submitted for event-related damages. Also, by incorporating IoT and image analysis, the system can identify the root causes of events, such as the lack of preventive maintenance, and use smart contract rules to validate claim amounts based on compliance levels. The augmentation of causal graphs through digital simulations can further enhance decision-making by providing valuable insights into the most probable reasons for the damage, ultimately leading to improved efficiency and accuracy throughout the insurance claim process.

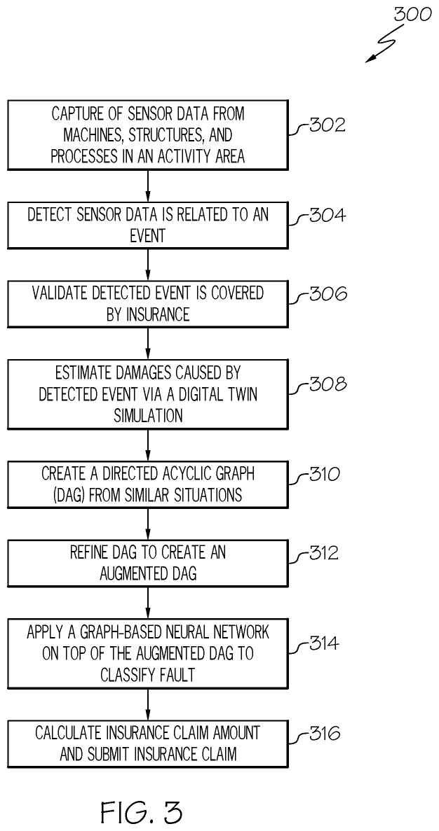

FIG. 3 depicts a flowchart diagram related to providing a real-time digital simulation and insurance claim submission in response to a detected event. At 302, data collection module 220 captures sensor data from various machines, structures, and processes within a specific activity area. This data serves as the foundation for further analysis and decision-making. At 304, event detection module 224 identifies if any sensor feed is related to an event such as an accident or improper execution. These events could be indicative of potential faults or issues that need attention.

Once an event is detected, at 306, event detection module 224 analyzes the details and characteristics of the event to determine if it falls within the scope of coverage provided by an insurance policy. This information can then be used by other modules to continue an appropriate insurance claim process or provide relevant notifications to the policyholder. To assess the damages caused by the detected event, simulation module 226 employs a digital twin simulation, at 308. This simulation creates a virtual replica of the affected system, allowing for a thorough examination of the damages and potential consequences. To enhance the understanding of similar situations, graphing module 228 generates a directed acyclic graph (DAG), at 310. This graph captures the relationships and dependencies between different events and serves as a reference for future analysis. At 312, the generated DAG is refined, resulting in an augmented DAG. This refinement process incorporates additional information and insights, making the augmented DAG more comprehensive and accurate.

To classify faults accurately, fault classifier module 230 applies a graph-based neural network on top of the augmented DAG, at 314. The graph structure is used to analyze and categorize different types of faults based on the available data. Once the fault is classified, at 316, claims processing module 232 calculates the insurance claim amount based on the damages estimated through the digital twin simulation. This ensures that the insurance claim accurately reflects the extent of losses incurred. At 316, claims processing module 232 submits the insurance claim, completing the process. By following these steps, assessment engine 250 enables efficient and accurate assessment of damages, classification of faults, and submission of insurance claims, streamlining the overall insurance process.

The illustrated steps in FIG. 3 are not necessarily performed in the order shown, and some steps may be performed concurrently or in a different order than shown. The flowchart diagram is intended to illustrate the general flow of the method and is not intended to be limiting. Additional steps may be added, or some steps may be omitted without departing from the scope of the invention. The steps may be performed by a computer program or by a combination of hardware and software. The flowchart diagram may be implemented using any suitable programming language or tool.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for assessing event damage, comprising:
obtaining, by an assessment engine, sensor data from objects having sensors within an activity area;
detecting, by the assessment engine, an event based on the sensor data;
generating, by the assessment engine, a real-time digital simulation to estimate a damages amount caused by the detected event;
generating, by the assessment engine, a directed acyclic graph to model similar scenario causation factors;
refining, by the assessment engine, the directed acyclic graph using data analysis and simulations to create an augment directed acyclic graph;
applying, by the assessment engine, a neural network architecture to the augmented directed acyclic graph to classify a fault; and
calculating, by the assessment engine, an insurance claim amount based on the estimated damages amount and the classified fault.

2. The method of claim 1, wherein the sensors include Internet of Things sensors.

3. The method of claim 1, further comprising submitting, by the assessment engine, an insurance claim using the insurance claim amount.

4. The method of claim 1, wherein the objects include at least one of a machine or structure.

5. The method of claim 1, further comprising analyzing, by the assessment engine, the sensor data to detect the event by identifying a pattern or anomaly within the data.

6. The method of claim 1, further comprising comparing, by the assessment engine, the sensor data against predefined criteria to detect an event.

7. The method of claim 1, further comprising analyzing, by the assessment engine, the sensor data to predict when maintenance is needed.

8. A computing system for assessing event damage, comprising:
a processor;
a memory device coupled to the processor; and
a computer readable storage device coupled to the processor, wherein the storage device contains program code executable by the processor via the memory device to implement a method, the method comprising:
obtaining, by an assessment engine, sensor data from objects having sensors within an activity area;
detecting, by the assessment engine, an event based on the sensor data;
generating, by the assessment engine, a real-time digital simulation to estimate a damages amount caused by the detected event;
generating, by the assessment engine, a directed acyclic graph to model similar scenario causation factors;
refining, by the assessment engine, the directed acyclic graph using data analysis and simulations to create an augment directed acyclic graph;
applying, by the assessment engine, a neural network architecture to the augmented directed acyclic graph to classify a fault; and
calculating, by the assessment engine, an insurance claim amount based on the estimated damages amount and the classified fault.

9. The computing system of claim 8, wherein the sensors include Internet of Things sensors.

10. The computing system of claim 8, the method further comprising submitting, by the assessment engine, an insurance claim using the insurance claim amount.

11. The computing system of claim 8, wherein the objects include at least one of a machine or structure.

12. The computing system of claim 8, the method further comprising analyzing, by the assessment engine, the sensor data to detect the event by identifying a pattern or anomaly within the data.

13. The computing system of claim 8, the method comprising comparing, by the assessment engine, the sensor data against predefined criteria to detect an event.

14. The computing system of claim 8, the method further comprising analyzing, by the assessment engine, the sensor data to predict when maintenance is needed.

15. A computer program product for assessing event damage, the computer program product comprising a computer readable storage device, and program instructions stored on the computer readable storage device, to:
obtain, by an assessment engine, sensor data from objects having sensors within an activity area;
detect, by the assessment engine, an event based on the sensor data;
generate, by the assessment engine, a real-time digital simulation to estimate a damages amount caused by the detected event;
generate, by the assessment engine, a directed acyclic graph to model similar scenario causation factors;
refine, by the assessment engine, the directed acyclic graph using data analysis and simulations to create an augment directed acyclic graph;
apply, by the assessment engine, a neural network architecture to the augmented directed acyclic graph to classify a fault; and
calculate, by the assessment engine, an insurance claim amount based on the estimated damages amount and the classified fault.

16. The computer program product of claim 15, wherein the sensors include Internet of Things sensors.

17. The computer program product of claim 15, further comprising program instructions stored on the computer readable storage device to submit, by the assessment engine, an insurance claim using the insurance claim amount.

18. The computer program product of claim 15, wherein the objects include at least one of a machine or structure.

19. The computer program product of claim 15, further comprising program instructions stored on the computer readable storage device to analyze, by the assessment engine, the sensor data to detect the event by identifying a pattern or anomaly within the data.

20. The computer program product of claim 15, further comprising program instructions stored on the computer readable storage device to compare, by the assessment engine, the sensor data against predefined criteria to detect an event.
